(19) United States
(12) Patent Application Publication
(10) Pub. No.: US 2025/0034440 A1
(43) Pub. Date: Jan. 30, 2025

(54) (METH)ACRYLATE-BASED TWO-COMPONENT ADHESIVE FORMULATION FOR ASSEMBLING WIND TURBINE BLADES

(71) Applicant: Bostik SA, COLOMBES (FR)

(72) Inventors: Emilie VAIQUE, Le Barp (FR); Valentin ANTUNES-VALLEREY, VENETTE (FR); Helena CHEMINET, WAUWATOSA, WI (US); Olivier FRADIN, COLOMBES CEDEX (FR)

(21) Appl. No.: 18/715,828

(22) PCT Filed: Dec. 5, 2022
(86) PCT No.: PCT/FR2022/052246

§ 371 Date: Jun. 3, 2024

(30) Foreign Application Priority Data
Dec. 6, 2021 (FR) 2113008

(51) Int. Cl. C09J 151/08; C08K 5/00; C08K 5/14; C09J 4/06; C09J 5/06

(52) U.S. Cl. CPC C09J 151/08; C08K 5/0016; C08K 5/14; C09J 4/06; C09J 5/06; C09J 2301/414; C09J 2451/00

(57) ABSTRACT

The invention relates to a two-component adhesive formulation comprising:
a composition (A) comprising:
   from 70% to 99.98% by weight of a liquid (meth)acrylic syrup comprising:
      a) a (meth)acrylic polymer,
      b) a (meth)acrylic monomer,
      said liquid (meth)acrylic syrup having a dynamic viscosity ranging from 10 mPa*s to 10 000 mPa*s;
   from 0.01% to 12% by weight of at least one urethane-methacrylate oligomer having a functionality of greater than or equal to 2,
   at least one activator,
a composition (B) comprising a radical initiator,
said initiator forming, on contact with said activator, a system that is able to initiate the polymerization of the (meth)acrylic monomer of composition (A).

### FIELD OF THE INVENTION

The present invention relates to a methacrylate-based two-component adhesive formulation and to the implementation thereof as a structural adhesive, particularly for repairing and/or assembling composite parts such as wind turbine blades or components thereof.

### TECHNICAL BACKGROUND

Existing adhesives in the field of wind energy are mainly based on thermosetting resins such as epoxy, vinyl ester or polyurethane resins.

Certain disadvantages might limit the use of these products in the future. The wind energy industry is seeking to improve productivity, all the more so since moulds represent a significant investment, in particular heating moulds. Manufacturers are seeking to reduce the initial investment and to shorten the stoppage time of these moulds as far as possible. Epoxy adhesives in particular require a supply of heat to perfect their polymerization, and cause many hours of stoppage time for the heating moulds. Another limitation relates to recyclability. There are currently no suitable recycling solutions for these thermosetting resins, and the blades end up being buried underground.

Moreover, it is important to develop adhesives which are sufficiently resistant to the chemical and mechanical stresses to which the blades are subjected during operation.

There is thus a real need to provide adhesive formulations for the field of wind energy, making it possible to at least partly overcome at least one of the abovementioned disadvantages.

There is particularly a need for adhesive formulations having good mechanical and adhesive properties, in particular over a wide temperature range.

There is also a need to provide such formulations which are also recyclable in order to enable recycling of wind turbine blades.

### SUMMARY OF THE INVENTION

The present invention relates to a two-component adhesive formulation comprising:
a composition (A) comprising:
   from 70% to 99.98% by weight of a liquid (meth)acrylic syrup comprising:
      a) a (meth)acrylic polymer,
      b) a (meth)acrylic monomer,
      said liquid (meth)acrylic syrup having a dynamic viscosity ranging from 10 mPa*s to 10 000 mPa*s;
   from 0.01% to 12% by weight of at least one urethane-(meth)acrylate oligomer having a functionality of greater than or equal to 2,
   at least one activator,
a composition (B) comprising a radical initiator,
said initiator forming, on contact with said activator, a system that is able to initiate the polymerization of the (meth)acrylic monomer of composition (A).

According to other optional and/or preferential characteristics of the two-component adhesive composition, to be considered in isolation or in combination:
the (meth)acrylic polymer is a methyl methacrylate (MMA) copolymer comprising at least 70%, preferably at least 80%, advantageously at least 90% and more advantageously at least 95% by weight of methyl methacrylate (MMA);
the (meth)acrylic polymer comprises a comonomer, said comonomer being an alkyl acrylate, the alkyl group having from 1 to 12 carbon atoms, particularly from 1 to 4 carbon atoms;
the (meth)acrylic polymer is a copolymer of methyl methacrylate and ethyl acrylate (MMA/EA);
the liquid syrup comprises from 40% to 90% by weight, preferably from 50% to 90% by weight, advantageously from 55% to 85% by weight, and more advantageously from 60% to 85% by weight of (meth)acrylic monomer relative to the total weight of the liquid (meth)acrylic syrup;
the urethane-(meth)acrylate oligomer has a glass transition temperature Tg of between 10° and 150° C., preferably between 110° C. and 130° C.;
the urethane-(meth)acrylate oligomer has a molar mass of less than 1500 g·mol⁻¹, particularly less than 1000 g·mol⁻¹;
the composition (A) comprises from 0.01% to 10% by weight, more preferentially from 0.1% to 7% by weight, and even more preferentially from 0.5% to 5% by weight of urethane-(meth)acrylate oligomer relative to the total weight of composition (A);
the composition (A) comprises from 0% to 40% by total weight of additive(s), preferably from 1% to 30% by weight relative to the total weight of said composition (A);
the composition (A) comprises, relative to the total weight of composition (A):
   from 70% to 95% by weight of liquid (meth)acrylic syrup, preferably from 70% to 90% by weight of liquid (meth)acrylic syrup;
   from 0.1% to 7% by weight of urethane-(meth)acrylate oligomer(s);
   from 0.1% to 5% by weight of activator(s);
   from 0% to 30% by weight of additive(s), preferably from 1% to 30% by weight of additive(s);
the composition (A) comprises, relative to the total weight of composition (A):
   from 70% to 95% by weight of liquid (meth)acrylic syrup, preferably from 70% to 90% by weight of liquid (meth)acrylic syrup;
   from 0.1% to 5% by weight of urethane-(meth)acrylate oligomer(s);
   from 0.1% to 5% by weight of activator(s);
   from 0.1% to 10% by weight of film-forming agent(s);
   from 0.1% to 10% by weight of impact modifier(s);
the composition (B) comprises, relative to the total weight of composition B:
   from 5% to 40% by weight of initiator;
   from 60% to 95% by weight of additives.
the composition (B) comprises:
   from 5% to 40% by weight of initiator;
   from 40% to 75% by weight of additives selected from non-reactive diluents, plasticizers and mixtures thereof, the non-reactive diluent(s) preferably being epoxy resins and functionalized vegetable oils;
   from 0% to 25% by weight of other additive(s), for instance rheological agent(s).

Another subject of the invention is a process for preparing an article comprising at least two assembled substrates, said process comprising:
i. mixing compositions (A) and (B) of the adhesive formulation according to the invention;
ii. applying the mixed adhesive formulation obtained in this way between a first and a second substrate;
iii. polymerizing the mixed adhesive formulation between the first and the second substrate, by means of which the two substrates are assembled.

Another subject of the invention is an article capable of being obtained according to this process.

Another subject of the invention relates to the use of a two-component adhesive formulation according to the invention for preparing and/or repairing and/or assembling composite parts such as wind turbine blades or components thereof.

The invention also relates to a wind turbine blade comprising a two-component adhesive formulation according to the invention, polymerized by mixing compositions (A) and (B), said polymerized two-component formulation being simultaneously in contact with a first substrate and a second substrate of a wind turbine blade.

The (meth)acrylate-based two-component adhesive composition can advantageously be polymerized at ambient temperature (23° C.) without supplying heat, which makes it possible to avoid the use of heating moulds and the stoppage time of same for long periods. The adhesive composition according to the invention advantageously enables a reduction in costs and a gain in productivity during the adhesive bonding phases.

The (meth)acrylate-based two-component adhesive composition advantageously leads to an adhesive layer having good mechanical and adhesive properties, in particular over a wide temperature range (for example from −40° C. to +50° C.). More particularly, it has been demonstrated that the polymerization of a liquid (meth)acrylate-based syrup in the presence of a urethane-(meth)acrylate oligomer advantageously made it possible to limit creep, in particular at high temperature, in particular at a temperature of greater than 50° C. Moreover, the adhesive compositions advantageously meet certain criteria stipulated by DNV, the chief certification body of the wind energy industry.

Moreover, the adhesive layer obtained from two-component formulations has a high glass transition temperature (Tg), particularly of greater than 50° C., which advantageously affords it stable behaviour, in particular in terms of temperature resistance and creep, over a wide temperature range which is particularly compatible with use in the field of wind energy.

These two-component adhesive formulations are thus particularly advantageous for preparing, repairing and/or assembling composite parts such as wind turbine blades or components thereof.

Finally, the (meth)acrylic polymers of the polymerized adhesive formulations can advantageously be recycled by chemical treatment and the methacrylate monomers can be recovered and recycled in other industrial fields and/or potentially within the field of wind energy.

### DESCRIPTION OF THE INVENTION

Thus, according to a first aspect, the invention relates to a two-component adhesive formulation comprising:
a composition (A) comprising:
   from 70% to 99.98% by weight of a liquid (meth)acrylic syrup comprising:
      a) a (meth)acrylic polymer,
      b) a (meth)acrylic monomer,
      said liquid (meth)acrylic syrup having a dynamic viscosity ranging from 10 mPa*s to 10 000 mPa*s;
   from 0.01% to 12% by weight of at least one urethane-(meth)acrylate oligomer having a functionality of greater than or equal to 2,
   an activator,
a composition (B) comprising a radical initiator,
said radical initiator forming, on contact with said activator, a system that is able to initiate the polymerization of the (meth)acrylic monomer of composition (A).

In the rest of the description, “polymer” either refers to a copolymer or to a homopolymer.

The term “monomer” as used refers to a molecule which can undergo polymerization.

The term “copolymer” means a polymer bringing together several different monomer units.

The term “polymerization” as used refers to the process for converting a monomer or a mixture of monomers into a polymer.

The term “homopolymer” means a polymer bringing together identical monomer units.

The term “block copolymer” means a polymer comprising one or more uninterrupted sequences of each of the separate polymer species, the polymer sequences being chemically different from each other and being bonded to each other via a covalent bond.

The term “(meth)acrylic” as used refers to any type of acrylic and methacrylic compounds, polymers, monomers or oligomers. However, it would not be departing from the scope of the invention if the (meth)acrylic matrix and/or the (meth)acrylic block copolymer were to comprise up to 10% by weight, preferably less than 5% by weight, of other nonacrylic monomers selected from the group: butadiene, isoprene, cyclosiloxanes, vinylnaphthalenes and vinylpyridines.

The term “thermoplastic polymer” as used refers to a polymer having a glass transition temperature Tg of greater than ambient temperature (23° C.).

The term “thermosetting polymer” as used refers to a plastic material which is converted irreversibly by polymerization into an insoluble polymer network.

For the purposes of the invention, an “oligomer” is a polymer compound of small size, comprising between 2 and 30 monomers, that is to say the degree of polymerization of which is between 2 and 30.

The term “initiator” as used refers to a chemical species that reacts with a monomer to form an intermediate compound capable of bonding in succession with a large number of other monomers in order to form a polymer. The initiator is a radical initiator, in particular a redox initiator, i.e. an initiator for which the production of radicals is the result of a redox reaction. The redox reaction can in particular result from coming into contact with an activator.

The term “activator” as used refers to a chemical species which is able to activate or accelerate the polymerization reaction, particularly by acting on the radical initiator. The activator generally makes it possible to activate the polymerization reaction at ambient temperature (23° C.) without requiring an external supply of heat.

The formulation according to the invention is a “two-component” composition, i.e. a formulation separated into two parts in order to prevent it from polymerizing by itself. A first part, in this case the composition (A), comprises the polymerizable species such as the (meth)acrylate monomers and the urethane-methacrylate oligomers, while a second part, in this case the composition (B), comprises the radical initiator of the polymerization reaction. Thus, the composition (B) may comprise a redox initiator, particularly an oxidizing initiator, which will be activated on contact with an activator, particular a reducing activator, present in composition (A). The polymerization reaction can therefore only be initiated when the composition (B) comprising the radical/oxidizing initiator and the composition (A) comprising the activator/reducing agent are brought into contact with each other.

### (Meth)acrylic Polymer

The (meth)acrylic polymer can be a polyalkyl methacrylate or a polyalkyl acrylate. In a preferred embodiment, the (meth)acrylic polymer is poly(methyl methacrylate) (PMMA).

The term “PMMA” as used denotes a methyl methacrylate homopolymer or copolymer or a mixture thereof.

The (meth)acrylic polymer can be a methyl methacrylate homopolymer or copolymer or a mixture thereof.

According to one embodiment, the methyl methacrylate (MMA) copolymer comprises at least 70%, preferably at least 80%, advantageously at least 90% and more advantageously at least 95% by weight of methyl methacrylate (MMA).

According to another embodiment, the methyl methacrylate (MMA) copolymer comprises from 70% to 99.7% by weight, preferably from 80% to 99.7% by weight, advantageously from 90% to 99.7% by weight and more advantageously from 90% to 99.5% by weight of methyl methacrylate and from 0.3 to 30% by weight, preferably from 0.3% to 20% by weight, advantageously from 0.3% to 10% by weight and more advantageously from 0.5% to 10% by weight of at least one monomer having at least one ethylenic unsaturation that can be copolymerized with the methyl methacrylate.

According to a further embodiment, the (meth)acrylic polymer comprises a comonomer, said comonomer being an alkyl acrylate, the alkyl group having from 1 to 12 carbon atoms, particularly from 1 to 4 carbon atoms. As examples, mention may particularly be made of methyl acrylate, ethyl acrylate or a mixture thereof.

The average molecular weight of the (meth)acrylic polymer is preferably greater than 50 000 g/mol and more preferentially greater than 100 000 g/mol.

The average molecular weight may particularly be measured by size exclusion chromatography.

According to a preferred embodiment, the (meth)acrylic polymer is a copolymer of methyl methacrylate and ethyl acrylate (MMA/EA). This copolymer preferably has a molecular weight of between 50 000 g/mol and 200 000 g/mol, even more preferentially between 100 000 g/mol and 150 000 g/mol.

### (Meth)Acrylic Monomer

The (meth)acrylic monomer can be selected from acrylic acid, methacrylic acid, alkyl acrylate monomers, alkyl methacrylate monomers or mixtures thereof, the alkyl group having from 1 to 22 carbon atoms, preferably 1 to 12 carbon atoms, and being linear, branched or cyclic.

Advantageously, the (meth)acrylic monomer is selected from methyl methacrylate, ethyl methacrylate, methyl acrylate, ethyl acrylate, methacrylic acid, acrylic acid, n-butyl acrylate, isobutyl acrylate, n-butyl methacrylate, isobutyl methacrylate, cyclohexyl acrylate, cyclohexyl methacrylate, isobornyl acrylate, isobornyl methacrylate or mixtures thereof.

More advantageously, the (meth)acrylic monomer is selected from methyl methacrylate, isobornyl acrylate, acrylic acid or mixtures thereof. It is more preferentially methyl methacrylate.

According to a preferred embodiment, at least 50% by weight, preferably at least 75% by weight, and even more preferentially at least 90%, of the (meth)acrylic monomer is methyl methacrylate.

### Liquid (Meth)Acrylic Syrup

The viscosity of the liquid (meth)acrylic syrup is high due to the presence of (meth)acrylic monomers or of a mixture of (meth)acrylic monomers forming a matrix in which one or more (meth)acrylic polymers are dissolved. This solution is commonly referred to as “syrup” or “prepolymer”.

Advantageously, the liquid (meth)acrylic syrup does not contain any additional solvent.

The (meth)acrylic polymer is preferably completely soluble in the (meth)acrylic monomer.

The liquid (meth)acrylic syrup can be prepared by simply mixing the (meth)acrylic polymer and the (meth)acrylic monomer, for example at 25° C.

The (meth)acrylic polymer is preferably PMMA, i.e. methyl methacrylate (MMA) homopolymer or copolymer or a mixture thereof as defined above.

The (meth)acrylic polymer in the liquid (meth)acrylic syrup can represent at least 10% by weight, preferably at least 15% by weight, advantageously at least 18% by weight, more advantageously at least 20% by weight of the total weight of the liquid (meth)acrylic syrup.

“Total weight of the liquid (meth)acrylic syrup” means the weight composed of the (meth)acrylic monomer and the (meth)acrylic polymer, the (meth)acrylic monomer and the (meth)acrylic polymer being as defined in the present description.

The (meth)acrylic polymer in the liquid (meth)acrylic syrup can represent at most 60% by weight, preferably at most 50% by weight, advantageously at most 40% by weight, more advantageously at most 35% by weight of the total weight of the liquid (meth)acrylic syrup.

The (meth)acrylic monomer in the liquid (meth)acrylic syrup can represent at least 40% by weight, preferably at least 50% by weight, advantageously at least 60%, more advantageously at least 65% by weight of the total weight of the liquid (meth)acrylic syrup.

The (meth)acrylic monomer in the liquid (meth)acrylic syrup can represent from 40% to 90% by weight, preferably from 50% to 90% by weight, advantageously from 55% to 85% by weight and more advantageously from 60% to 85% by weight of the total weight of the liquid (meth)acrylic syrup.

As a result, the (meth)acrylic polymer in the liquid (meth)acrylic syrup can represent from 10% to 60% by weight, preferably from 10% to 50% by weight, advantageously from 15% to 45% by weight, and more advantageously from 15% to 40% by weight of the total weight of the liquid (meth)acrylic syrup.

The dynamic viscosity of the liquid (meth)acrylic syrup is in a range from 10 mPa*s to 10 000 mPa*s, preferably from 50 mPa*s to 5000 mPa*s and advantageously from 100 mPa*s to 1000 mPa*s. The viscosity of the syrup can be readily measured with a rheometer or a viscometer. The dynamic viscosity is measured at 25° C. The liquid (meth)acrylic syrup exhibits Newtonian behaviour and therefore the dynamic viscosity is independent of the shearing in a rheometer or the speed of the spindle in a viscometer.

### Urethane-(meth)acrylate Oligomer

The composition (A) of the adhesive formulation according to the invention comprises a urethane-(meth)acrylate oligomer having a functionality of greater than or equal to 2.

“Functionality of greater than or equal to 2” means an oligomer having at least two functions, particularly two unsaturations, such as two (meth)acryloyloxyalkylene functions which are able to copolymerize with the (meth)acrylic monomer.

The urethane-(meth)acrylate oligomer can comprise one or more urethane bonds (—OCONH—), particularly between the polyether and/or polyester and/or polyol blocks.

According to a preferred embodiment, the urethane-(meth)acrylate oligomer comprises at least two terminal (meth)acryloyloxyalkylene functions (-Alk-CO₂—C(H/CH₃)=CH₂), the alkylene group (-Alk-) preferably having from 2 to 8, advantageously from 2 to 6, and more advantageously from 2 to 4, carbon atoms.

The urethane-(meth)acrylate oligomer can comprise a polyurethane comprising two terminal (meth)acryloyloxyalkylene functions (-Alk-CO₂—C(H/CH₃)═CH₂), at each end.

The urethane-(meth)acrylate oligomer can have a symmetrical triblock structure, B-A-B, comprising a central polyether block A bonded respectively by chemical bonds of two diisocyanate molecules to two terminal hydrophobic blocks B based on hydrophobic polyester oligomers, having a terminal (meth)acryloyloxyalkylene group.

More particularly, said polyurethane oligomer has the following general formula (1):

B—OCONH—R—NHCOO-A-OCONH—R—NHCOO—B (1)
in which:
A is the residue of a polyether diol
OCONH—R—NHCOO: urethane bond formed by the reaction of said polyether diol with a diisocyanate compound R—(NCO)₂, wherein:
R is a divalent aromatic, aliphatic or cycloaliphatic group, preferably aliphatic, in particular having at least 6 carbon atoms, or else R has a cycloaliphatic structure including in particular a hydrogenated aromatic structure,
B is the moiety of a hydrophobic polyester oligomer, preferably a polycaprolactone oligomer, bearing in the terminal position a (meth)acryloyloxyalkylene group bonded to said polyester oligomer chain, preferably polycaprolactone oligomer, by an ester bond (—CO₂).

According to another embodiment, the urethane-(meth)acrylate oligomer results from an esterification reaction of a polyurethane polyol or polyurethane monool with acrylic or methacrylic acid, or from a reaction of a polyisocyanate polyurethane prepolymer and a hydroxyalkyl (meth)acrylate.

The urethane-(meth)acrylate oligomer can have a glass transition temperature Tg of between 10° and 150° C., preferably between 110° C. and 130° C., as measured particularly by dynamic mechanical analysis (DMA).

The urethane-(meth)acrylate oligomer can have a molar mass of less than 1500 g·mol⁻¹, particularly less than 1000 g·mol⁻¹.

The urethane-(meth)acrylate oligomer preferably represents from 0.01% to 10% by weight, more preferentially from 0.1% to 7% by weight, and even more preferentially from 0.5% to 5% by weight of the total weight of composition (A).

Reference may be made to the urethane-(meth)acrylate oligomers sold by Sartomer, for example under the name CN1993 CG or CN 1963CG.

### Polymerization Initiator

The initiator making it possible to initiate the polymerization reaction of the monomers and oligomers present in composition (A) is a radical initiator, i.e. an initiator that generates radicals, for which the production of radicals is particularly the result of a redox reaction.

Thus, the radical initiator can be a redox initiator. This preferably reacts by a redox reaction with an activator present in composition (A), to generate free radicals and to initiate the polymerization of the (meth)acrylic monomers and the urethane-(meth)acrylate oligomers.

The radical initiator is preferably selected from peroxides or diperoxides having from 2 to 20 carbon atoms, and the radical initiator is even more preferentially dibenzoyl peroxide or cumene hydroperoxide.

The content of radical initiator can be greater than or equal to 5% by weight, preferably ranging from 5% to 40% by weight relative to the total weight of composition (B). The content of radical initiator is given as percentage by weight of active material relative to the total weight of composition (B).

### Polymerization Activator

The adhesive formulation comprises a polymerization activator. As indicated above, the activator advantageously reacts with the radical initiator to generate the formation of radicals, particularly via a redox reaction, preferably at ambient temperature (23° C.).

The activator can be selected from tertiary amines, for instance N,N-dimethyl-p-toluidine (DMPT) or N,N-dihydroxyethyl-p-toluidine (DHEPT).

The composition (A) can comprise a total weight of activator(s) ranging from 0.1% to 5% by weight relative to the total weight of composition (A).

Additives of composition (A)

The composition (A) may comprise one or more additives.

Among the additives, mention may for example be made of organic additives such as impact modifiers or block copolymers, heat stabilizers, UV stabilizers, lubricants, rheological agents, film-forming agents, adhesion promoters, flame retardants and mixtures thereof; and inorganic additives such as inorganic fillers.

The composition (A) can comprise from 0% to 40% by total weight of additive(s), preferably from 1% to 30% by weight relative to the total weight of said composition (A).

The impact modifier can be in the form of fine particles having an elastomeric core and at least one thermoplastic shell, the size of the particles being in general less than 1 μm and advantageously between 50 and 300 μm. The impact modifier can be prepared by emulsion polymerization.

The total content of impact modifier(s) in composition (A) can range from 0% to 50% by weight, preferably from 0% to 25% by weight, and advantageously from 1% to 20% by weight relative to the total weight of said composition (A).

Among impact modifiers, mention may for example be made of “core-shells” based on MBS (MMA-butadiene-styrene) and ABS.

Preferably, the composition (A) comprises an impact modifier.

Preferably, the composition (A) comprises a film-forming agent which makes it possible to limit the reaction of the unsaturated compounds contained in the adhesive formulation with atmospheric molecular oxygen and to obtain a longer open time before polymerization of the adhesive formulation.

The film-forming agent is preferably a mixture of waxes, such as paraffins, comprising polar compounds such as isodecyl ether and polyoxyethylene.

“Open time” means, as used, the time between the start of mixing of the compositions (A) and (B) and the start of polymerization of the adhesive formulation, during which time the user can apply the formulation to the substrate(s) that they wish to assemble.

Advantageously, the adhesive formulations according to the invention make it possible to have an open time of greater than or equal to 20 minutes, or even greater than or equal to 1 hour.

The composition (A) can comprise from 0% to 20% by total weight of film-forming agent(s), preferably from 0.1% to 10% by weight, and even more preferentially from 0.1% to 5% by weight, relative to the total weight of said composition (A).

As examples of heat stabilizers, mention can be made of hydroquinone (HQ), methylhydroquinone (MEHQ), 2,6-di-tert-butyl-4-methoxyphenol (Topanol 0) and 2,4-dimethyl-6-tert-butylphenol (Topanol A). These heat stabilizers make it possible to prevent the monomers in formulation (A) from polymerizing spontaneously.

As examples of rheological agent(s), mention may be made of any rheological agent customarily used in the field of adhesive compositions.

The rheological agents are preferably selected from:
PVC plastisols, corresponding to a suspension of PVC in a plasticizer that is miscible with PVC, obtained in situ by heating to temperatures ranging from 60° C. to 80° C. These plastisols may be those described especially in the publication Polyurethane Sealants, Robert M. Evans, ISBN 087762-998-6,
fumed silica, as sold, for example, under the name HDK® N20 by Wacker;
urea derivatives derived from the reaction of an aromatic diisocyanate monomer such as 4,4′-MDI with an aliphatic amine such as butylamine. The preparation of such urea derivatives is particularly described in patent application FR 1 591 172;
micronized amide waxes, such as Crayvallac® SLT or Crayvallac® SLA sold by Arkema.

The adhesion promoters can be selected from silanes, such as aminosilanes, epoxysilanes or acryloyl silanes, or adhesion promoters based on a phosphate ester, for instance the 2-hydroxyethyl methacrylate phosphate ester, 2-methacryloyloxyethyl phosphate, bis(2-methacryloyloxyethyl phosphate), 2-acryloyloxyethyl phosphate, bis(2-acryloyloxyethyl phosphate), methyl(2-methacryloyloxyethyl phosphate), ethyl(2-methacryloyloxyethyl phosphate), a mixture of 2-hydroxyethyl methacrylate mono- and diphosphate esters. Mention may for example be made of JPA514 sold by KOWA, or SR9051 sold by Sartomer.

The UV stabilizers are typically introduced to protect the composition from degradation resulting from a reaction with oxygen which is liable to be formed by the action of heat or light. These compounds may include primary antioxidants which trap free radicals. The primary antioxidants can be used alone or in combination with other secondary antioxidants or UV stabilizers.

Mention may be made, for example, of Irganox® 1010, Irganox® B561, Irganox® 245, Irgafos®168, Tinuvin® 328 or Tinuvin™ 770, which are sold by BASF.

By way of examples of inorganic filler, use may be made of any mineral filler customarily used in the field of adhesive compositions. These fillers are typically in the form of particles of diverse geometry. They may be, for example, spherical or fibrous or may have an irregular shape.

The inorganic filler may be selected from the group consisting of clay, quartz, carbonate fillers, kaolin, gypsum, clays, and mixtures thereof.

The inorganic filler can be untreated or treated, for example treated using an organic acid, such as stearic acid, or a mixture of organic acids predominantly consisting of stearic acid.

Use may also be made of hollow mineral microspheres, such as hollow glass microspheres, and more particularly those made of calcium sodium borosilicate or of aluminosilicate.

According to one embodiment, the composition (A) comprises, relative to the total weight of the composition (A):
from 70% to 95% by weight of liquid (meth)acrylic syrup, preferably from 70% to 90% by weight of liquid (meth)acrylic syrup;
from 0.1% to 7% by weight of urethane-(meth)acrylate oligomer(s);
from 0.1% to 5% by weight of activator(s);
from 0% to 30% by weight of additive(s), preferably from 1% to 30% by weight of additive(s).

According to a preferred embodiment, the composition (A) comprises, relative to the total weight of the composition (A):
from 70% to 95% by weight of liquid (meth)acrylic syrup, preferably from 70% to 90% by weight of liquid (meth)acrylic syrup;
from 0.1% to 5% by weight of urethane-(meth)acrylate oligomer(s);
from 0.1% to 5% by weight of activator(s);
from 0.1% to 10% by weight of film-forming agent(s);
from 0.1% to 10% by weight of impact modifier(s).

### Additives of Composition (B)

The composition (B) may comprise one or more additives.

Among the additives, mention may for example be made of organic additives such as non-reactive diluents, heat stabilizers, UV stabilizers, lubricants, rheological agents, film-forming agents, plasticizers, adhesion promoters, flame retardants and mixtures thereof; and inorganic additives such as inorganic fillers.

The description of the additives of composition (A) above also applies to the additives mentioned in composition (B).

According to one embodiment, the composition (B) comprises, relative to the total weight of the composition (B):
from 5% to 40% by weight of initiator;
from 60% to 95% by weight of additives.

Among the non-reactive diluents, mention may for example be made of epoxy resins, functionalized vegetable oils, and mixtures thereof.

The epoxy resin may be aliphatic, cycloaliphatic, heterocyclic or aromatic.

The epoxy resin may be monomeric or polymeric.

The epoxy resin covers any epoxy resin, whether functionalized or not, for instance elastomer-modified epoxy resins which are typically obtained by reaction between a base epoxy resin and an elastomer comprising terminal functions that react with the epoxy functions.

The epoxy resin may be selected from:
polyglycidyl ethers of polyphenolic compounds, preferably comprising from 2 to 6 glycidyl ether functions per mole of resin,
derivatives thereof (typically elastomer-modified resins); and
mixtures thereof.

A polyphenolic compound is a compound having at least two aromatic hydroxyl groups.

The polyphenolic compounds can be selected from the group consisting of resorcinol, catechol, hydroquinone, bisphenol A (2,2-bis(4-hydroxyphenyl)propane), bisphenol AP (1,1-bis(4-hydroxyphenyl)-1-phenylethane), bisphenol AF (2,2-bis(4-hydroxyphenyl)hexafluoropropane), bisphenol B ((2,2-bis(4-hydroxyphenyl)butane), bisphenol BP (bis(4-hydroxyphenyl)diphenylmethane), bisphenol C (2,2-bis(3-methyl-4-hydroxyphenyl)propane), bisphenol CII (bis(4-hydroxyphenyl)-2,2-dichloroethylene), bisphenol E (1,1-bis(4-hydroxyphenyl)ethane), bisphenol F (bis(4-hydroxyphenyl)-2,2-dichloroethylene), bisphenol FL (4,4′-(9H-fluoren-9-ylidene)bisphenol, bisphenol G (2,2-bis(4-hydroxy-3-isopropylphenyl)propane), bisphenol M (1,3-bis(2-(4-hydroxyphenyl)-2-propyl)benzene), bisphenol P (1,4-bis(2-4-hydroxyphenyl)-2-propyl)benzene), bisphenol PH (5,5′-(1-methylethylidene)-bis[1,1′-(bisphenyl)-2-ol]propane), bisphenol S (bis(4-hydroxyphenyl)sulfone), bisphenol TMC (1,1-bis(4-hydroxyphenyl)-3,3,5-trimethylcyclohexane); bisphenol Z (1,1-bis(4-hydroxyphenyl)cyclohexane), bisphenol K, tetraethylbiphenol, and mixtures thereof.

Numerous epoxy resins are typically commercially available. Mention may for example be made of the D.E.R.™ 331 and D.E.R.™ 383 resins sold by Dow Chemicals, the EPON 862 resin sold by Hexion Specialty Chemicals, the EPOSIR® resins based on bisphenol A sold by SIR Industrial (for example EPOSIR® 7120), and the EPOSIR® resins based on bisphenol A/bisphenol F (for example EPOSIR® F556), the modified resins STRUKTOL POLYDIS 3622 (CAS no. 25068-38-6) sold by STRUKTOL and Araldite GY 250 sold by HUNTSMAN.

The functionalized vegetable oils may be epoxidized vegetable oils (containing at least one epoxy function).

As examples of plasticizing agents that may be used, mention may be made of any plasticizing agent customarily used in the field of adhesives, for instance epoxy resins, phthalates, benzoates, trimethylolpropane esters, trimethylolethane esters, trimethylolmethane esters, glycerol esters, pentaerythritol esters, naphthenic mineral oils, adipates, cyclohexyldicarboxylates, paraffinic oils, natural oils (optionally epoxidized), polypropylenes, polybutylenes, hydrogenated polyisoprenes, alkylphenol sulfonates, and mixtures thereof.

The total content of non-reactive diluent(s) in composition (B) can range from 0% to 80%, preferably from 10% to 75%, even more preferentially from 20% to 70%, relative to the total weight of said composition (B).

The composition (B) preferably comprises, relative to the total weight of composition (B):
from 5% to 40% by weight of initiator;
from 40% to 75% by weight of additives selected from non-reactive diluents, plasticizers and mixtures thereof, the non-reactive diluent(s) preferably being epoxy resins and functionalized vegetable oils;
from 0% to 25% by weight of other additive(s), for instance rheological agent(s).

### Process for Preparing an Article Comprising at Least Two Assembled Substrates

According to a second aspect, the invention relates to a process for preparing an article comprising at least two assembled substrates, said process comprising:
i. mixing compositions (A) and (B) of the adhesive formulation as defined above;
ii. applying the mixed adhesive formulation obtained in this way between a first and a second substrate;
iii. polymerizing the mixed adhesive formulation between the first and the second substrate, by means of which the two substrates are assembled.

In step i), the compositions (A) and (B) of the adhesive formulation can be mixed in a static mixer.

The volume ratio of the compositions (A)/(B) can range from 20/1 to 1/1; it is preferably equal to 10/1.

In step ii), the formulation is generally applied before the start of the polymerization of the mixture of (A) and (B), i.e. during the open time.

The adhesive formulation is typically applied at the outlet of the mixer, for example to the wind turbine blades or components to be assembled.

Advantageously, the polymerization in step iii) is carried out at a temperature of less than 40° C., particularly between 10° C. and 30° C., in particular at ambient temperature (23° C.), particularly at the end of the open time, in particular without it being necessary to supply an external source of heat or moisture.

The first and/or second substrates can be independently selected from composite materials, particularly based on acrylic, or metal materials.

Advantageously, the first and second substrates are wind turbine blade components or wind turbine blades.

### Article Comprising at Least Two Assembled Substrates

According to a third aspect, the invention relates to an article capable of being obtained according to the process as defined above, preferably a wind turbine blade or a component thereof.

According to yet another aspect, the invention relates to a wind turbine blade comprising a two-component adhesive formulation as defined in the present description, polymerized by mixing compositions (A) and (B), said polymerized two-component formulation being simultaneously in contact with a first substrate and a second substrate of a wind turbine blade.

Use for Preparing and/or Repairing, Particularly for Assembling, Wind Turbine Blades

According to yet another aspect, the invention relates to a two-component adhesive formulation as defined above for preparing, repairing and/or assembling composite parts, for instance wind turbine blades or components thereof.

### Recycling Articles Comprising at Least Two Assembled Substrates

The article comprising at least two assembled substrates can be recycled by grinding or depolymerization of the polymer resulting from the adhesive formulation.

The article comprising the polymer is preferably heated to cause pyrolysis or thermal decomposition of the PMMA and to recover methyl methacrylate as monomer.

The article can in particular be heated at a temperature of between 200° C. and 400° C.

Advantageously, at least 50% by weight of the MMA present in the polymer is recovered after thermal decomposition.

Thus, according to yet another aspect, the invention relates to the use of a two-component adhesive formulation as defined above for preparing or assembling recyclable wind turbine blades, particularly by depolymerization.

All the embodiments described above may be combined with each other. In particular, the various abovementioned constituents of the composition, and particularly the preferred embodiments of the composition, may be combined with each other.

In the context of the invention, the term “between x and y” or “ranging from x to y” means a range in which the limits x and y are included. For example, the range “between 0% and 25%” particularly includes the values 0% and 25%.

### EXAMPLES

The following ingredients were used:
Urethane-methacrylate U1 having a functionality of 2 and a Mw of between 500 and 1000 g/mol and a Tg of between 100° C. and 150° C., sold by Sartomer;
Impact modifier M1, sold by Arkema (block copolymer based on MBS, MMA-butadiene-styrene);
SR9054 (CAS no.: 1628778-81-3) sold by Sartomer: difunctional acrylic acid adhesion promoter;
Bisomer® PTE (CAS no.: 103671-44-9), amine activator sold by GEO Specialty Chemicals;
Crayvallac® SLT sold by Arkema: micronized amide wax rheological agent;
HDK®N20 (CAS no.: 112945-52-5) sold by Wacker, hydrophilic fumed silica;
AEROSIL® R208 (CAS no.: 7631-86-9) sold by Evonik, hydrophilic fumed silica;
MEHQ (CAS no.: 150-76-5) sold by Camlin (radical reaction heat stabilizer);
TALKRON® CL40 (CAS no.: 14807-96-6) sold by Mineralia;
BYK® 750N (CAS no.: 64742-55-8 and 61827-42-7), film-forming agent sold by BYK-Chemie;
Araldite® GY250 (CAS no.: 1675-54-3) bisphenol A diglycidyl ether (DGEBA) additive sold by HUNTSMAN;
PEROXAN BP-Paste 50 PF1, 50% active material (CAS no.: 94-36-0), dibenzoyl peroxide (oxidizer) sold by PERGAN.

### Example 1: Preparation of the Liquid Syrup

A liquid syrup is prepared by dissolving 20 parts of a polymethyl methacrylate (BS520 from Arkema: MMA/ethyl acrylate copolymer) in 80 parts of methyl methacrylate (MMA) in the presence of MEHQ as stabilizer. The liquid syrup obtained has a dynamic viscosity of 500 to 600 mPa*s at 25° C.

### Example 2: Composition No. 1 (According to the Invention)

The various ingredients constituting the component A are mixed in the proportions shown in the following table, at a temperature of 23° C., in a stirred reactor.

The various ingredients constituting the component B are mixed in the proportions shown in the following table, at a temperature of 23° C., in a continuously stirred reactor.

Composition 1

| Component A | | Component B | |
|---|---|---|---|
| | % by weight | | % by weight |
| | (relative to the | | (relative to the |
| Ingredients | weight of A) | Ingredients | weight of B) |
| Liquid syrup of | 78.83 | PEROXAN BP | 29.5 |
| Example 1 | | PASTE 50PF1 | |
| Urethane- | 1.0 | Araldite GY 250 | 66 |
| methacrylate | | | |
| U1 | | | |
| Impact modifier | 7.5 | | |
| M | | | |
| Crayvallac ® | 4.0 | PEROXAN BP | 30 |
| SLT | | paste 50 PF1 | |
| | | Aerosil R208 | 4 |
| HDKN 20 | 3.50 | | |
| TALC | 1.5 | | |
| MEHQ | 0.07 | | |
| SR9054 | 1.0 | | |
| BYK ® 750N | 2.0 | | |
| Bisomer ® PTE | 0.6 | | |
| Total: | 100 | Total: | 100 |

The mixing is carried out at ambient temperature (2300), at a component A/component B volume ratio of 10/1, with a static mixer.

### Example 3: Comparative Composition No. 2 (without Urethane-Methacrylate)

The various ingredients constituting the component A are mixed in the proportions shown in the following table, at a temperature of 2300, in a stirred reactor.

The various ingredients constituting the component B are mixed in the proportions shown in the following table, at a temperature of 2300, in a continuously stirred reactor.

Composition No. 2 (comparative)

| Component A | | Component B | |
|---|---|---|---|
| | % by weight | | % by weight |
| | (relative to the | | (relative to the |
| Ingredients | weight of A) | Ingredients | weight of B) |
| Liquid syrup of | 81.63 | PEROXAN BP | 29.5 |
| Example 1 | | PASTE 50PF1 | |
| | | Araldite GY 250 | 66 |
| Impact modifier | 6.0 | | |
| M1 | | | |
| Crayvallac ® | 2.5 | PEROXAN ® BP | 30 |
| SLT | | paste 50 PF1 | |
| | | Aerosil R208 | 4 |
| HDKN 20 | 4.70 | | |
| TALC | 1.5 | | |
| MEHQ | 0.07 | | |
| SR9054 | 1.0 | | |
| BYK ® 750N | 2.0 | | |
| Bisomer ® PTE | 0.6 | | |
| Total: | 100 | Total: | 100 |

### Example 4: Results

### Adhesive Bonding Tests

The adhesive bondings are produced on strips made of glass fibre composite. An area of 25×12.5 mm was delimited on a strip using wedges made of Teflon with a thickness of 3 mm. This area was filled with the composition to be tested, then a second strip of the same material was laminated. The combination was held by a clamp and placed in a climate-controlled chamber at 23° C. for a week before tensile testing on a universal testing machine. The aim of the tensile testing on a universal testing machine is to evaluate the maximum force (in MPa) to be applied to the assemblage in order to separate it. Using a tensile testing device makes it possible to subject a simple lap joint placed between two rigid supports to a shear stress until failure by exerting tension on the supports parallel to the surface of the assemblage and to the main axis of the test specimen. The result to be recorded is the breaking force or stress. The shear stress is applied via the movable jaw of the tensile testing device with a displacement at the rate of 5 mm/min. This tensile testing method is carried out as defined by the standard EN 1465: 2009.

### Creep Test:

The creep test specimens are produced on strips made of glass fibre composite. An area of 25×12.5 mm was delimited on a strip using wedges made of Teflon with a thickness of 3 mm. This area was filled with the composition to be tested, then a second strip of the same material was laminated. The combination was held by a clamp and placed in a climate-controlled chamber at 23° C. for a week before being subject to stressing on a creep test bench. The aim is to evaluate the creep of the adhesive seal under stress at 60° C. for 192 h. This bench makes it possible to perform tensile creep tests in a climate-controlled chamber at 60° C. The force applied is 2 MPa on one of the strips.

The result to be noted is the measurement of elongation of the adhesive seal (expressed in mm).

The properties obtained for compositions no. 1 (invention) and no. 2 (comparative) are summarized in the following table:

| | Shear test at 23° C. | | Shear test at −40° C. | | Shear test at 50° C. | | |
|---|---|---|---|---|---|---|---|
| | Fmax | Breaking | Fmax | Breaking | Fmax | Breaking | Creep at 60° |
| | (MPa) | pattern | (MPa) | pattern | (MPa) | pattern | C. (192 h) |
| Composition | | | | | | | |
| Composition 1 (Example 2) | 15.2 | SD | 14.3 | SD | 12.4 | CF | 0.2 mm |
| Composition 2 (Example 3) | 16.9 | SD | 16 | SD | 14.9 | CF | disassembly* |

SD: Substrate delamination
CF: cohesive failure
Fmax: maximum force at the time of the failure of the adhesive bonding.
*Disassembly is the coming apart of the two strips composing the assemblage.

Composition no. 1 advantageously has good adhesion properties after crosslinking, over a wide temperature range (23° C., from −40° C. to 50° C.). The values are particularly greater than 12 MPa, which is advantageously greater than the threshold value required by the DNV (DNVGL-CP-0086).

Moreover, composition no. 1 according to the invention advantageously has better creep resistance than comparative composition no. 2, which does not contain urethane-methacrylate. Indeed, the creep after 192 h is advantageously less than 1 mm (0.2 mm), while (comparative) composition no. 2 leads to disassembly after 50 hours.

### Exercise 5: Composition No. 3 (Comparative)

The various ingredients constituting the component A are mixed in the proportions shown in the following table, at a temperature of 23° C., in a stirred reactor.

The various ingredients constituting the component B are mixed in the proportions shown in the following table, at a temperature of 23° C., in a continuously stirred reactor.

Composition no. 3 (comparative)

| Component A | | Component B | |
|---|---|---|---|
| | % by weight | | % by weight |
| | (relative to the | | (relative to the |
| Ingredients | weight of A) | Ingredients | weight of B) |
| Liquid syrup of | 64.83 | PEROXAN BP | 30 |
| Example 1 | | PASTE 50PF1 | |
| Urethane- | 15.0 | Araldite GY 250 | 66 |
| methacrylate | | | |
| U1 | | | |
| Impact modifier | 7.5 | Aerosil R208 | 4 |
| M1 | | | |
| Crayvallac ® | 4.0 | | |
| SLT | | | |
| HDKN 20 | 3.50 | | |
| TALC | 1.5 | | |
| MEHQ | 0.07 | | |
| SR9054 | 1.0 | | |
| BYK 750N | 2.0 | | |
| Bisomer ® PTE | 0.6 | | |
| Total: | 100 | Total: | 100 |

The properties obtained according to tests similar to those mentioned in Example 4 are summarized in the following table:

| | Shear test at −40° C. | | |
|---|---|---|---|
| | Fmax | Breaking | Creep at 60° C. |
| | (MPa) | pattern | (192 h) |
| Composition no. 3 | 9.2 | SD | 1.1 mm |
| (comparative) | | | |

Comparative composition no. 3 leads to poorer adhesion properties than composition no. 1 (invention) at −40° C. (9.2 MPa versus 14.3 MPa for composition no. 1).

In addition, composition no. 1 (invention) advantageously has better creep resistance than comparative composition no. 3.

1-15. (canceled)

16. A two-component adhesive formulation comprising:
a composition (A) comprising:
from 70% to 99.98% by weight of a liquid (meth)acrylic syrup comprising:
a) a (meth)acrylic polymer, and
b) a (meth)acrylic monomer,
said liquid (meth)acrylic syrup having a dynamic viscosity ranging from 10 mPa*s to 10 000 mPa*s;
from 0.01% to 12% by weight of at least one urethane-(meth)acrylate oligomer having a functionality of greater than or equal to 2, and
at least one activator,
a composition (B) comprising a radical initiator,
said initiator forming, on contact with said activator, a system that is able to initiate the polymerization of the (meth)acrylic monomer of composition (A).

17. The formulation as claimed in claim 16, wherein the (meth)acrylic polymer is a methyl methacrylate (MMA) copolymer comprising at least 70%, by weight of methyl methacrylate (MMA).

18. The formulation as claimed in claim 16, wherein the (meth)acrylic polymer comprises a comonomer, said comonomer being an alkyl acrylate, the alkyl group having from 1 to 12 carbon atoms.

19. The formulation as claimed in claim 16, wherein the (meth)acrylic polymer is a copolymer of methyl methacrylate and ethyl acrylate (MMA/EA).

20. The formulation as claimed in claim 16, wherein the liquid syrup comprises from 40% to 90% by weight, of (meth)acrylic monomer relative to the total weight of the liquid (meth)acrylic syrup.

21. The formulation as claimed in claim 16, wherein the urethane-(meth)acrylate oligomer has a glass transition temperature Tg of between 10° and 150° C.

22. The formulation as claimed in claim 16, wherein the urethane-(meth)acrylate oligomer has a molar mass of less than 1500 g·mol⁻¹.

23. The formulation as claimed in claim 16, wherein the composition (A) comprises from 0.01% to 10% by weight, of urethane-(meth)acrylate oligomer relative to the total weight of composition (A).

24. The formulation as claimed in claim 16, wherein the composition (A) comprises from 0% to 40% by total weight of additive(s) relative to the total weight of said composition (A).

25. The formulation as claimed in claim 16, wherein the composition (A) comprises, relative to the total weight of composition (A):
from 70% to 95% by weight of liquid (meth)acrylic syrup;
from 0.1% to 7% by weight of urethane-(meth)acrylate oligomer(s);
from 0.1% to 5% by weight of activator(s); and
from 0% to 30% by weight of additive(s).

26. The formulation as claimed in claim 16, wherein the composition (B) comprises, relative to the total weight of composition B:
from 5% to 40% by weight of initiator; and
from 60% to 95% by weight of additives.

27. A process for preparing an article comprising at least two assembled substrates, said process comprising:
i. mixing compositions (A) and (B) of the adhesive formulation as claimed in claim 16;
ii. applying the mixed adhesive formulation obtained in this way between a first and a second substrate;
iii. polymerizing the mixed adhesive formulation between the first and the second substrate, by means of which the two substrates are assembled.

28. An article capable of being obtained according to the process of claim 27.

29. A wind turbine blade comprising a two-component adhesive formulation as claimed in claim 16, polymerized by mixing compositions (A) and (B), said polymerized two-component formulation being simultaneously in contact with a first substrate and a second substrate of a wind turbine blade.

30. The formulation as claimed in claim 25, wherein the composition (A) comprises, relative to the total weight of composition (A):
from 70% to 95% by weight of liquid (meth)acrylic syrup;
from 0.1% to 5% by weight of urethane-(meth)acrylate oligomer(s);
from 0.1% to 5% by weight of activator(s);
from 0.1% to 10% by weight of film-forming agent(s); and
from 0.1% to 10% by weight of impact modifier(s).

31. The formulation as claimed in claim 26, wherein the composition (B) comprises, relative to the total weight of composition B:
from 5% to 40% by weight of initiator;
from 40% to 75% by weight of additives selected from non-reactive diluents, plasticizers and mixtures thereof; and
from 0% to 25% by weight of other additive(s).
